(19) United States
(12) Patent Application Publication
(10) Pub. No.: US 2026/0093841 A1
(43) Pub. Date: Apr. 2, 2026

(54) SECURITY MANAGEMENT MODES OF A MULTI-PORT MEMORY SYSTEM

(71) Applicant: Micron Technology, Inc., Boise, ID (US)

(72) Inventors: John E. Maroney, Irvine, CA (US); Pedro Cordon, Irvine, CA (US); Henry H. Torabi, Irvine, CA (US); Robert W. Strong, Irvine, CA (US)

(21) Appl. No.: 19/340,750

(22) Filed: Sep. 25, 2025

Related U.S. Application Data
(60) Provisional application No. 63/701,304, filed on Sep. 30, 2024.

(51) Int. Cl. G06F 21/62; G06F 21/60

(52) U.S. Cl. CPC G06F 21/6218; G06F 21/604

(57) ABSTRACT

Methods, systems, and devices for security management modes of a multi-port memory system are described. A multi-port memory system may be configured to operate according to one or more security modes that adjust access by host systems to the multiple ports of the memory system. For example, in a first mode, which may be referred to herein as a port security management mode, the memory system may restrict access by unauthenticated host systems to ports of the memory system, such that any unauthenticated host systems have no access to the memory system via the ports or are limited to a relatively primitive set of commands until the host systems are authenticated. In a second mode, which may be referred to herein as an operational mode, any host systems coupled with ports of the memory system are granted, without authentication, full access to a command set supported by the memory system.

### CROSS REFERENCE

The present Application for Patent claims priority to U.S. Patent Application No. 63/701,304 by Maroney et al., entitled “SECURITY MANAGEMENT MODES OF A MULTI-PORT MEMORY SYSTEM,” filed Sep. 30, 2024, which is assigned to the assignee hereof, and which is expressly incorporated by reference in its entirety herein.

### TECHNICAL FIELD

The following relates to one or more systems for memory, including security management modes of a multi-port memory system.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports security management modes of a multi-port memory system in accordance with examples as disclosed herein.

FIG. 2 shows an example of an architecture that supports security management modes of a multi-port memory system in accordance with examples as disclosed herein.

FIG. 3 shows an example of a process flow that supports security management modes of a multi-port memory system in accordance with examples as disclosed herein.

FIG. 4 shows a block diagram of a memory system that supports security management modes of a multi-port memory system in accordance with examples as disclosed herein.

FIG. 5 shows a flowchart illustrating a method or methods that support security management modes of a multi-port memory system in accordance with examples as disclosed herein.

### DETAILED DESCRIPTION

Some memory systems (e.g., in automotive systems) may utilize multiple ports for managing or executing commands from multiple external host systems (e.g., for multiple user applications) in parallel. For example, multiple external host systems may each be coupled with the memory system via the multiple ports (e.g., a respective external host system may be coupled with a memory system through a respective port) and may utilize resources at the memory system for execution of application-specific commands. In some examples, based on a host system establishing a connection with the memory system via at least one of the multiple ports, the host system may transmit and receive commands or other signaling with the memory system via one or more in-band channels to support execution of one or more applications. In-band channels may represent examples of channels coupled between one or more host systems and at least one port of the memory system and used for transferring data traffic as well as management information for the memory system. However, in some cases, granting external host systems unrestricted access to in-band signaling with the memory system may pose a security risk and may allow malicious actors to access commands and perform one or more security attacks, which may reduce the security of the memory system and of the user data stored therein.

In accordance with examples described herein, a multi-port memory system (e.g., a multi-port solid state drive (SSD), such as an automotive SSD, among other examples) may be configured to operate according to one or more security modes that adjust access by host systems to the multiple ports of the memory system. For example, in a first mode, which may be referred to herein as a port security management mode, the memory system may restrict (e.g., block or otherwise limit) access by unauthenticated host systems to ports of the memory system, such that an unauthenticated host system is not able to access the memory system via the ports or is limited to a relatively primitive set of commands until the host system is authenticated. In a second mode, which may be referred to herein as an operational mode, any host systems coupled with ports of the memory system are granted (e.g., immediately grated, granted without authentication) full access (e.g., or less restricted access) to a command set supported by the memory system for accessing data stored within the memory system, or for executing applications hosted by the host system, or both. In some examples, the memory system may represent an example of or otherwise be included within an automotive system (e.g., an automotive SSD) or another type of system associated with relatively high reliability and security requirements, and the techniques described herein for security management modes of a multi-port memory system may improve security and data integrity within the automotive system, thereby increasing user experience and mitigating risks from security attacks, among other examples.

In addition to applicability in memory systems described herein, techniques for security management modes of a multi-port memory system may be generally implemented to improve security and/or authentication features of various electronic devices and systems. As the use of electronic devices for handling private, user, or other sensitive information has become even more widespread, electronic devices and systems have become the target of increasingly frequent and sophisticated attacks. Further, unauthorized access or modification of data in security-critical devices such as vehicles, healthcare devices, and others may be especially concerning. Implementing the techniques described herein may improve the security of electronic devices and systems by verifying and attesting host systems that seek access to a multi-port memory system, and may prevent or mitigate unauthorized access to data or other information and may prevent access by malicious actors to commands of the memory system that could be used to perform security attacks, among other benefits. Additionally, the memory system may be implemented within an automotive system (e.g., an automotive SSD), and may thereby support relatively increased security for the automotive system.

Features of the disclosure are illustrated and described in the context of systems, devices, and circuits. Features of the disclosure are further illustrated and described in the context of architectures, process flows, block diagrams, and flowcharts.

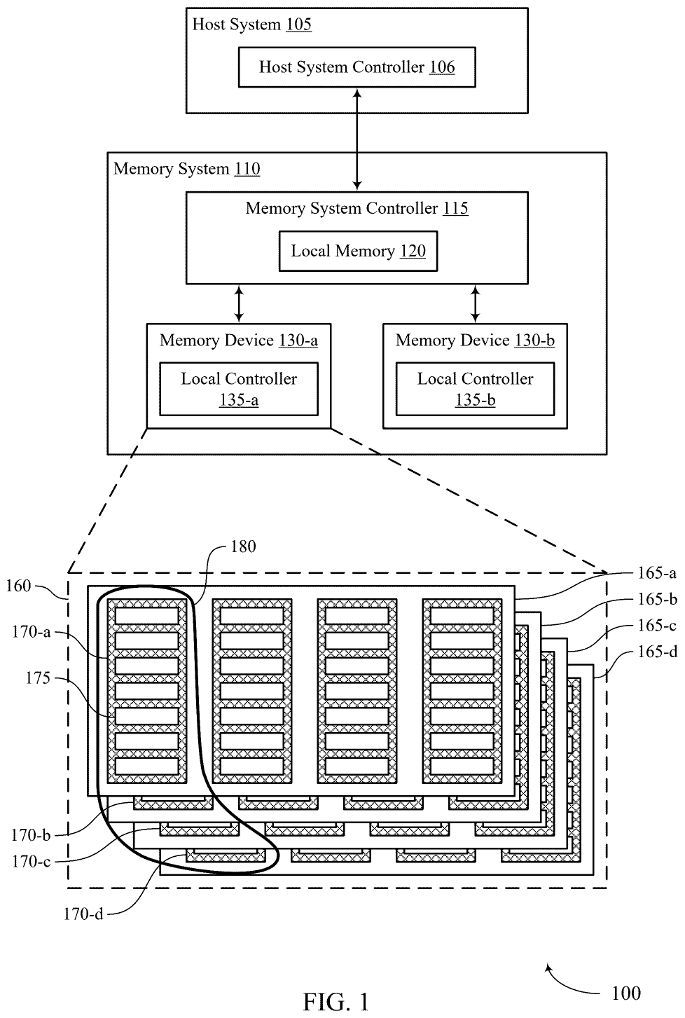

FIG. 1 shows an example of a system 100 that supports security management modes of a multi-port memory system in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices. In some cases, the memory system 110 may be implemented as part of an automotive system (e.g., as an automotive SSD). For example, the host system 105 may be an example of a host system on an automotive platform.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b. A local controller 135 may be or include a microcontroller, special purpose logic circuitry (e.g., a field programmable gate array (FPGA), an application specific integrated circuit (ASIC), a digital signal processor (DSP)), or any other suitable processor or processing circuitry.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

Some memory systems 110 (e.g., in automotive systems) may utilize multiple ports for managing or executing commands from multiple external host systems 105 (e.g., for multiple user applications) in parallel. For example, multiple external host systems 105 may be individually coupled with the memory system 110 via the multiple ports and may utilize resources (e.g., memory devices 130) at the memory system 110 for execution of application-specific commands. In some examples, based on a host system 105 establishing a connection with the memory system 110 via one of the multiple ports, the host system 105 may transmit and receive commands or other signaling with the memory system 110 via both in-band and OOB channels to support execution of one or more applications. However, in some cases, granting external host systems 105 unrestricted access to in-band signaling with the memory system 110 may pose a security risk and may allow malicious actors to access commands and perform one or more security attacks, which may reduce the security of the memory system 110 and of the user data stored therein (e.g., stored in memory devices 130).

In accordance with examples described herein, a multi-port memory system 110 (e.g., a multi-port SSD, such as an automotive SSD, among other examples) may be configured to operate according to one or more security modes that adjust access by host systems 105 to the multiple ports of the memory system 110. For example, in a first mode, which may be referred to herein as a port security management mode, the memory system 110 may restrict (e.g., block) access by unauthenticated host systems 105 to ports of the memory system 110, such that any unauthenticated host systems 105 have no access to the memory system via the ports or are limited to a relatively primitive set of commands until the host systems 105 are authenticated. In a second mode, which may be referred to herein as an operational mode, any host systems 105 coupled with ports of the memory system 110 are granted (e.g., immediately grated, granted without authentication) full access (e.g., or less restricted access) to a command set supported by the memory system 110 for accessing data stored within the memory system 110, for executing applications hosted by the host system 105, or both. In some examples, the memory system 110 may represent an example of or otherwise be included within an automotive system (e.g., an automotive SSD) or another type of system associated with relatively high reliability and security requirements, and the techniques described herein for security management modes of a multi-port memory system 110 may improve security and data integrity within the automotive system, thereby increasing user experience and mitigating risks from security attacks, among other examples.

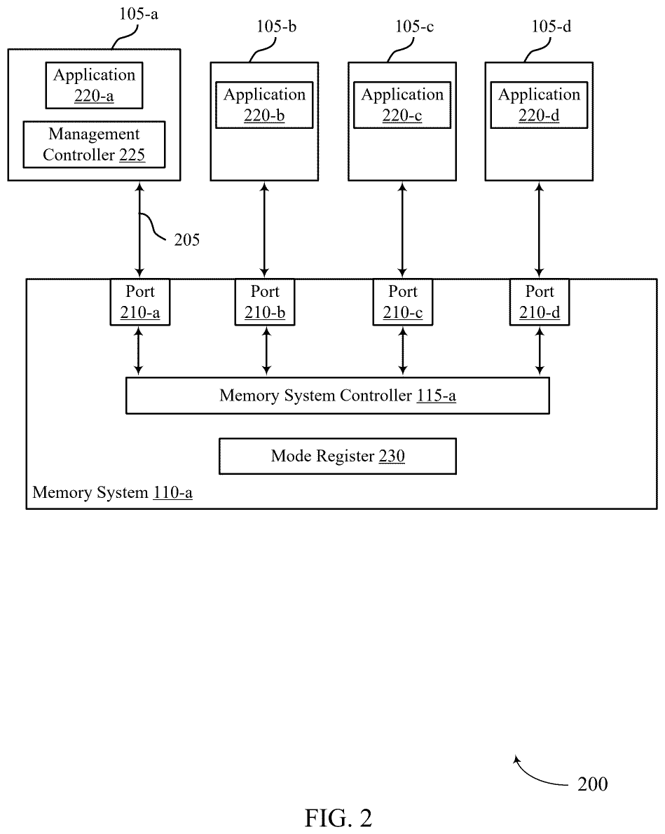

FIG. 2 shows an example of an architecture 200 that supports security management modes of a multi-port memory system in accordance with examples as disclosed herein. The architecture 200 may implement or may be implemented by aspects of the system 100. For example, the architecture 200 may include a host system 105-a, a host system 105-b, a host system 105-c, a host system 105-d, and a memory system 110-a, which may be examples of corresponding devices or systems described herein. In some cases, the architecture 200 may be implemented in or as part of an automotive system, and architecture 200 may support increased security of user data and reduced security risks posed by malicious actors, among other benefits.

The memory system 110-a may be a multi-ported memory system and may include a port 210-a, a port 210-b, a port 210-c, and a port 210-d. The ports 210 may allow for multiple host systems 105 to establish connections with the memory system 110-a and to execute commands using the memory system 110-a for executing applications 220 (e.g., or functions). For example, a host system 105-a may be coupled with the memory system 110-a via the port 210-a and may host (e.g., and may execute commands for) an application 220-a. A host system 105-b may be coupled with the memory system 110-a via the port 210-b and may host an application 220-b, a host system 105-c may be coupled with the memory system via the memory system 110-a via the port 210-c and may host an application 220-c, and a host system 105-d may be coupled with the memory system 110-a via the port 210-d and may host an application 220-d. Although the architecture 200 illustrates four host systems 105 and four ports 210, it is to be understood that a memory system may include any quantity and combination of ports and host systems, including four of each, or any other quantities. The memory system 110-a may include one or more memory arrays across one or more memory devices that store data for the execution of the various applications. The ports may provide an interface for communicating commands and data with the host systems 105, but the actual data for each host system 105 may be stored in various locations within the memory system 110-a.

In some examples, the host systems 105 may transmit commands (e.g., in-band commands) that are associated with execution of an application 220. The host systems 105 may be controlled by or may include one or more components or systems of an automotive platform, and applications 220 may support one or more functions of the automotive platform or some other type of platform. Such commands may be communicated to the memory system 110-a via a peripheral component interconnect (PCI) interface 205 between a host system 105 and a port 210 of the memory system 110-a, which may be referred to as an in-band channel. In-band channels may represent examples of channels coupled between one or more host systems and at least one port of the memory system and used for transferring data traffic as well as management information for the memory system. The host systems 105 may communicate with the memory system 110-a using the ports 210 via in-band signaling (e.g., via a PCI express (PCIe) bus), which may differ from OOB signaling. For example, the PCI interface 205 may support transfer of data and commands, while one or more OOB channels may represent examples of channels or other connections between the host systems 105 and the memory system 110-a that may be used solely for management purposes (e.g., and may not be used for regular data traffic). Commands sent by a host system 105 may cause or instruct a memory system controller 115-a to execute operations, access memory (e.g., at one or more memory devices 130 of the memory system 110-a), or both. The commands may be non-volatile memory express (NVMe) commands, or some other type of command.

In some examples, the memory system 110-a may be configured with a trusted port, which may be the port 210-a (e.g., or any other port 210 may be configured as the trusted port). In accordance with the examples described herein, in the port security management mode, the memory system 110-a may use the trusted port 210-a for authentication of the host systems 105 prior to the memory system 110-a granting the host systems 105 access to the ports 210. For example, the memory system 110-a may grant a management controller 225 of a host system 105-a access to the trusted port 210-a based on an attestation process between the memory system 110-a and the host system 105-a. The management controller 225 (e.g., a central management controller, a management operating system) may be included in the host system 105-a and may be used for managing one or more aspects of the host system 105-a, the host system 105-b, the host system 105-c, the host system 105-d, or for managing one or more connections between the host systems 105 and the ports 210, or both. The host system 105-a and the memory system 110-a may perform the attestation process by transmitting one or more vendor defined messages (e.g., vendor specific commands) that are transmitted via an NVMe management interface (NVMe-MI) associated with the trusted port 210-a, or some other interface (e.g., management interface).

Once authenticated with the memory system 110-a, the host system 105-a (e.g., the management controller 225) may (e.g., via the NVMe-MI interface and via the trusted port 210-a) request that any one or more host systems 105 gain access (e.g., privileged access) to a respective port 210 of the memory system 110-a. For example, the host system 105-a, which may be referred to herein as a trusted host system 105, may transmit one or more commands (e.g., vendor specific commands) that request that the host system 105-b gain privileged access to the port 210-b, that the host system 105-c gain privileged access to the port 210-c, and so on. The host system 105-a (e.g., the management controller 225) may attest each host system 105 one-by-one using separate signaling to the trusted port 210-a, or a single command may be used to request access for the multiple host systems to each respective port 210 (e.g., to attest the multiple host systems 105). The host systems 105 may communicate with the management controller 225 of the host system 105-a via one or more backend interfaces or other connections within a host system (e.g., a motherboard, a host PCB, or the like). As such, the host systems 105 may, in some examples, send a request to the management controller 225 of the host system 105-a for access to the memory system 110-a.

In some examples, the management controller 225 may transmit one or more commands to request access for host system 105-a to gain privileged access to the port 210-a. For example, though the host system 105-a may have access to a set of management commands communicated with the memory system 110-a via the NVMe-MI of the port 210-a, the host system 105-a may further be granted access by the memory system 110-a for transmitting commands on an NVMe interface or PCIe interface different than the NVMe-MI, which may include commands for execution of the application 220-a.

In some examples, prior to the trusted host system 105-a authenticating the host systems 105 for access to the multiple ports 210, the memory system 110-a may be in a port security management mode in which authorization, by host systems 105, to use various commands for accessing the memory system 110-a while coupled with a corresponding port 210 may be reduced (e.g., restricted, limited). For example, though the host system 105-b is coupled with the port 210-b, the host system 105-b may not be authenticated with the memory system 110-a. Accordingly, the host system 105-b may have access to a limited first set of commands for executing operations supported by the multi-ported memory system 110-a, or may not be able to access any commands. Accessing commands as described herein may include generating, transmitting, or successfully executing the commands, among other examples. For example, the host system 105-b may not be able to transmit commands outside of the first set of commands, or the host system 105-b may transmit the commands, but the memory system 110-a may block or refrain from executing the commands that are not included in the first set of commands during the port management mode and before the host system 105-b is attested. In response to the trusted host system 105-a attesting the host system 105-b, the port 210-b, or both (e.g., as trusted and/or authenticated), the memory system 110-a (e.g., a memory system controller 115-a) may grant the host system 105-b access (e.g., increased access) to a second set of commands. The second set of commands may be associated with increasing (e.g., and less restrictive) access to one or more memory cells of the memory system 110-a (e.g., increasing access to memory devices 130). For example, the second set of commands may include a greater quantity of commands relative to the first set of commands, such as read, write, and erase commands, among other examples.

In some other examples, the memory system 110-a may be configured in an operational mode (e.g., a manufacturing mode) in which access by host systems 105 to commands of the memory system 110-a while coupled with a corresponding port 210 is unrestricted. Accordingly, any host systems 105 may have access to the second set of commands, and the second set of commands may correspond to a full set of commands supported by the memory system or may be associated with increasing access to functions of the memory system 110-a relative to the first set of commands. In the operational mode of the memory system 110-a, host systems 105 may have access to the second set of commands without authentication and may perform any commands from the second set of commands without restriction or blockage.

The memory system 110-a may enter one of the security modes of the memory system (e.g., the port security management mode or the operational mode) based on a default configuration configured for the memory system 110-a. For example, during a bootup sequence (e.g., power on, reset) of the memory system 110-a, one or more values from a mode register 230 of the memory system 110-a may be read by the memory system controller 115-a. In one example, the mode register 230 may indicate that a default mode of the memory system 110-a is the port security management mode and that access to the memory system 110-a via the multiple ports 210 is restricted to the first set of commands until authentication. The mode register 230 may indicate the first set of commands and the second set of commands, may indicate whether authentication of the ports 210 (e.g., or the host systems 105) is via a system management bus or via vendor defined messages via NVMe-MI, or may indicate that a trusted port 210-a is used for attesting the ports 210, or any combination thereof.

In a second example, the mode register 230 may indicate that a default mode of the memory system 110-a is the operational mode and that access to the memory system 110-a via the multiple ports 210 is unrestricted or is according to the second set of commands. In some examples, a configuration of the default security mode of the memory system 110-a (e.g., indicated via the mode register 230) may indicate that the default security mode applies to a subset of the host systems 105 and that other ports 210 are assigned a second security mode different than the default security mode. Additionally, or alternatively, a first subset of the ports 210 may be configured in the port security management mode while a second subset of the ports 210 is configured in the operational mode. In some examples, the memory system 110-a may receive a vendor specific message that indicates for the memory system 110-a to enter one of the security modes (e.g., the port security management mode, the operational mode).

In some examples, the memory system 110-a may be configured to use various setups or configurations of the ports 210, which may be indicated to the memory system 110-a via the mode register 230 (e.g., which is read after power up) or is signaled to the memory system 110-a via the port 210-a (e.g., from the management controller 225 of the host system 105-a). For example, the memory system 110-a may be configured to use a subset of the ports 210 (e.g., only one port 210-a is activated, two ports are activated, or the like) or may be configured to use the ports 210 in a different configuration (e.g., two ports with two lanes each, four ports with one lane each, etc.).

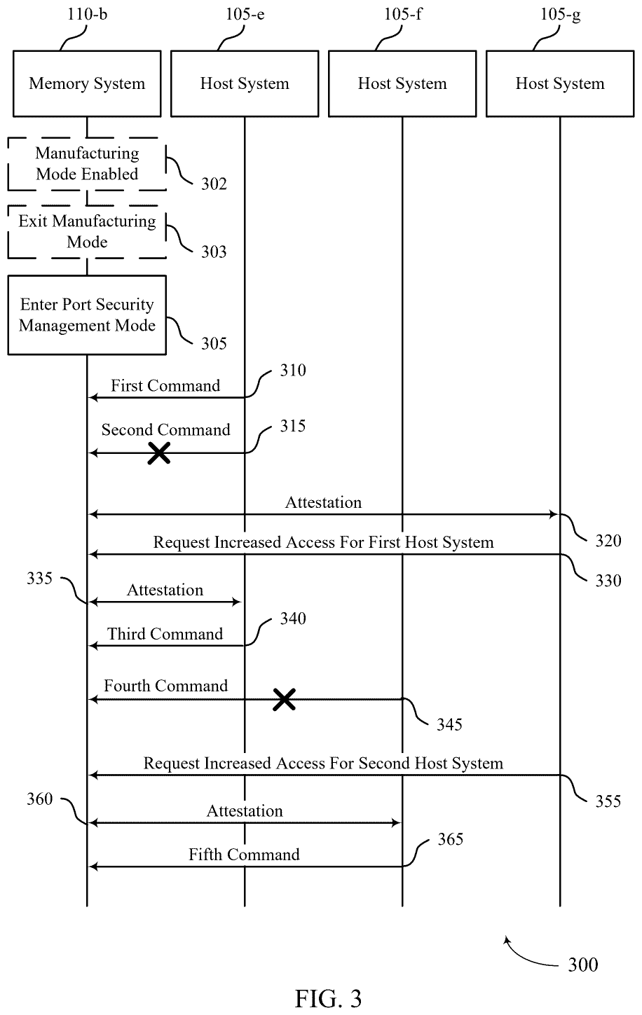

FIG. 3 shows an example of a process flow 300 that supports security management modes of a multi-port memory system in accordance with examples as disclosed herein. The process flow 300 may implement or may be implemented by aspects of the system 100 or the architecture 200. For example, the process flow 300 may include a memory system 110-b, a host system 105-e, a host system 105-f, and a host system 105-g, which may be examples of corresponding devices described herein. The host system 105-g may be a trusted host system as described herein and may include a management controller 225 as described with reference to FIG. 2. The process flow 300 is depicted to start at 302 and end at 365, but may include additional operations (not shown), or operations may be omitted, modified, or performed in a different order in accordance with the described techniques. In some examples, the host systems 105 may be controlled by or may include one or more components or systems of an automotive platform and may execute one or more automotive applications.

At 302, in some examples, a manufacturing mode of the memory system 110-b may be enabled. For example, during manufacture of the memory system 110-b, a manufacturing mode may be enabled or otherwise turned on. The memory system 110-b may be shipped to a customer while in the manufacturing mode. The manufacturing mode may be set based on one or more values of mode registers (e.g., the mode register 230). The manufacturing mode may be associated with one or more test operations of the memory system 110-b after or during manufacture and prior to deployment of (e.g., operation of) the memory system 110-b, for example. The manufacturing mode may grant any host system 105 (e.g., the host system 105-e, the host system 105-f, the host system 105-g) that is coupled with a port of the memory system 110-b unrestricted access to a set of commands supported by the memory system 110-b for execution of applications hosted by the host systems 105. That is, during a testing phase, the security of the memory system 110-b may be relatively limited, as a likelihood of a malicious actor and the effects such an actor would have may be limited during testing.

At 303, the memory system 110-b may exit the manufacturing mode. That is, the manufacturing mode may be disabled (e.g., by setting a value in one or more mode registers). The memory system 110-b may exit the manufacturing mode based on the memory system 110-b being deployed external to the factory (e.g., turned on or otherwise initiated external to the factory).

At 305, the memory system 110-b may enter a port security management mode associated with reduced access to the memory system 110-b by the host system 105-e, by the host system 105-f, by other host systems 105 coupled with the memory system 110-b via one or more ports of multiple ports of the memory system 110-b, or any combination thereof. For example, the memory system 110-b may enter the port security management mode based on the manufacturing mode being disabled at 303, based on a power up sequence or reset of the memory system 110-b, based on the memory system 110-b receiving a vendor specific command (e.g., from the trusted host system 105-g), based on one or more values of mode registers, or a combination thereof. The memory system 110-b may, in some examples, enter the port security management mode during any power-up sequence after the memory system 110-b has been manufactured and deployed external to a factory, for example.

The host system 105-e may be coupled with a first port (e.g., a port 210-b) of the memory system 110-b via a first host interface (e.g., a PCI interface) and the host system 105-f may be coupled with a second port (e.g., a second port 210-c) of the memory system 110-b via a second host interface (e.g., a PCI interface). In the port security management mode, the host system 105-e and the host system 105-f may have access to a first set of commands of the memory system 110-b, which may be a reduced set of one or more commands (e.g., NVMe commands) supported by the memory system 110-b via the first host interface and the second host interface, which may be in-band interfaces (e.g., PCI interfaces). The host system 105-e and the host system 105-f may be granted access to a second set of commands (e.g., an increased set of commands) after authentication with the memory system 110-b via the trusted host system 105-g (e.g., via NVMe-MI signaling or vendor defined messages).

At 310, the memory system 110-b may receive a first command from the host system 105-e via the first port, and the first command may be included in the first set of commands which are accessible by the host system 105-e (e.g., or any host system 105 irrespective of authentication) while the memory system 110-b is in the port security management mode. The memory system 110-b may execute the first command based on receiving the first command from the host system 105-e via the first port (e.g., and based on the first command being included in the first set of unprivileged/unrestricted commands). In some examples, the first set of commands may not access or modify data stored to the memory system 110-b and may be associated with other general queries or requests associated with relatively low security threats.

At 315, the memory system 110-b may receive a second command from the host system 105-e via the first port, and the second command may be included in the second set of commands which are restricted for the host system 105-e prior to authentication based on the port security management mode of the memory system 110-b. The memory system 110-b may refrain from executing the second command based on receiving the second command from the host system 105-e via the first port and the host system 105-e being unauthenticated in accordance with the port security management mode.

At 320, the memory system 110-b may grant, based on an attestation process between the memory system 110-b and the host system 105-g, access by the host system 105-g (e.g., and the management controller 225 of the host system 105-g) to a third port (e.g., a trusted port) of the memory system 110-b. The host system 105-g (e.g., a management controller 225) may communicate with the memory system 110-b (e.g., via the trusted port) via a management interface (e.g., an NVMe-MI) different than the first host interface and the second host interface. Access by the host system 105-g to commands of the management interface may be based on a configuration of the third port as the trusted port of the memory system 110-b, and the host system 105-g may be a trusted host system based on the coupling of the host system 105-g with the trusted port. In some examples, the host system 105-g may be able to initiate the attestation process autonomously or without support from other components external to the memory system 110-b and the host system 105-g based on the host system 105-g being the trusted host system (e.g., based on a field, flag, or one or more other indications in one or more messages sent by the host system 105-g. Additionally, or alternatively, because the host system 105-g is coupled with the third port, which is designated as a trusted port of the memory system 110-b, the memory system 110-b may permit a request to attest the host system 105-g.

At 330, the memory system 110-b may receive, from the host system 105-g via the trusted port (e.g., and via the management interface), a command that requests increased access for at least the host system 105-e. The host system 105-g may transmit the command to request increased access based on the host system 105-g being authenticated (e.g., attested), or based on the host system 105-g communicating with the memory system 110-b via the trusted port or the management interface, or both. In some examples, the request from the host system 105-g may request for the increased access to be granted for multiple host systems 105 (e.g., or corresponding ports 210) which may be coupled with the memory system 110-b via other ports different than the first port (e.g., which may include the host system 105-g itself).

In some examples, the host system 105-e may transmit, via one or more backend connections, a request to the host system 105-g to provide increased access for the host system 105-e based on one or more functions or applications to be executed by the host system 105-e, for example. The host system 105-g may transmit the request at 330 in response to the request from the host system 105-e, in such cases.

At 335, the memory system 110-b may perform an attestation process (e.g., via the first port) between the memory system 110-b and the host system 105-e coupled with the first port in response to the request from host system 105-g. For example, in direct response to receiving the request from the host system 105-g, the memory system 110-b (e.g., a memory system controller 115) may exchange one or more messages with the host system 105-e to verify or otherwise attest the host system 105-e before switching an authentication status of the host system 105-e, the first port, or both (e.g., from unauthenticated to authenticated). The memory system 110-b may grant increased access, to data in the memory system 110-b by the host system 105-e via the first port, from the first set of commands to a second set of commands that includes an expanded set of commands (e.g., a greater quantity of commands) relative to the first set of commands. In some examples, the memory system 110-b (e.g., a memory system controller 115) may store (e.g., maintain) an authentication status of the host system 105-e, an authentication status of the first port (e.g., and authentication statuses of other host systems 105 and other ports 210), or any combination thereof in memory.

At 340, the memory system 110-b may receive a third command from the host system 105-e via the first port, and the third command may be included in the second set of commands which are restricted for the host system 105-e prior to authentication based on the port security management mode of the memory system 110-b. The memory system 110-b may execute the third command based on receiving the third command from the host system 105-e via the first port and based on granting the increased access by the host system 105-e to the memory system 110-b, or based on switching the authentication status of the host system 105-e or the first port, or any combination thereof.

At 345, the memory system 110-b may receive a second command from the host system 105-f via the first port, and the second command may be included in the second set of commands which are restricted for the host system 105-f prior to authentication based on the port security management mode of the memory system 110-b. The memory system 110-b may refrain from executing the second command based on receiving the second command from the host system 105-f via the first port and the host system 105-f being unauthenticated in accordance with the port security management mode.

At 355, the memory system 110-b may receive, from the host system 105-g via the trusted port (e.g., and via the management interface), a command that requests increased access for at least the host system 105-f. The host system 105-g may transmit the command to request increased access based on the host system 105-g being authenticated (e.g., attested), or based on the host system 105-g communicating with the memory system 110-b via the trusted port and/or the management interface.

In some examples, the host system 105-f may transmit, via one or more backend connections, a request to the host system 105-g to provide increased access for the host system 105-f based on one or more functions or applications to be executed by the host system 105-f, for example. The host system 105-g may transmit the request at 355 in response to the request from the host system 105-f, in such cases.

At 360, the memory system 110-b may perform an attestation process (e.g., via the second port) between the memory system 110-b and the host system 105-f coupled with the second port in response to the request from the host system 105-g. For example, in direct response to receiving the request from the host system 105-g, the memory system 110-b (e.g., a memory system controller 115) may attest the host system 105-f, may switch an authentication status of the host system 105-f, the second port, or both (e.g., from unauthenticated to authenticated), and may grant increased access by the host system 105-f via the second port from the first set of commands to the second set of commands that includes an expanded set of commands (e.g., a greater quantity of commands) relative to the first set of commands. Additionally, or alternatively, the memory system 110-b may grant access by the host system 105-f to a third set of commands different than the first set of commands and the second set of commands based on a configuration of the port security management mode or based on an indication from the host system 105-g. In some examples, the memory system 110-b (e.g., a memory system controller 115) may store (e.g., maintain) an authentication status of the host system 105-f, an authentication status of the second port, or both in memory.

At 365, the memory system 110-b may receive a fifth command from the host system 105-f via the second port, and the fifth command may be included in the second set of commands which are restricted for the host system 105-f prior to authentication based on the port security management mode of the memory system 110-b. The memory system 110-b may execute the fifth command based on receiving the fifth command from the host system 105-e via the second port and based on granting the increased access by the host system 105-f to the memory system 110-b, or based on switching the authentication status of the host system 105-f or the second port, or any combination thereof.

The memory system 110-b described herein may thereby default to operating in one of a port management mode or an operational mode (e.g., among other possible security modes, including a manufacturing mode) after bootup of the memory system 110-b. The memory system 110-b may trust any host systems connected to ports of the memory system 110-b without authentication during the operational mode, and the memory system 110-b may not trust any host systems 105 connected to any ports of the memory system 110-b during the port management mode. The memory system 110-b may be configured with a trusted port for communicating with a management controller of a trusted host system 105-g, and the trusted port may be the single (e.g., only) trusted port during the port management mode (e.g., or there may be two or more trusted ports). The memory system 110-b may thereby support an attestation process with the host system 105-g, and may subsequently receive one or more management commands from the host system 105-g, including commands to increase access to other host systems 105. The memory system 110-b may transition from the port management mode to other operating modes based on the commands and as the memory system 110-b attests or otherwise authorizes the one or more other host systems 105. The described techniques may thereby provide for a more secure memory system 110-b that is less susceptible to malicious attacks and modification attempts, among other examples.

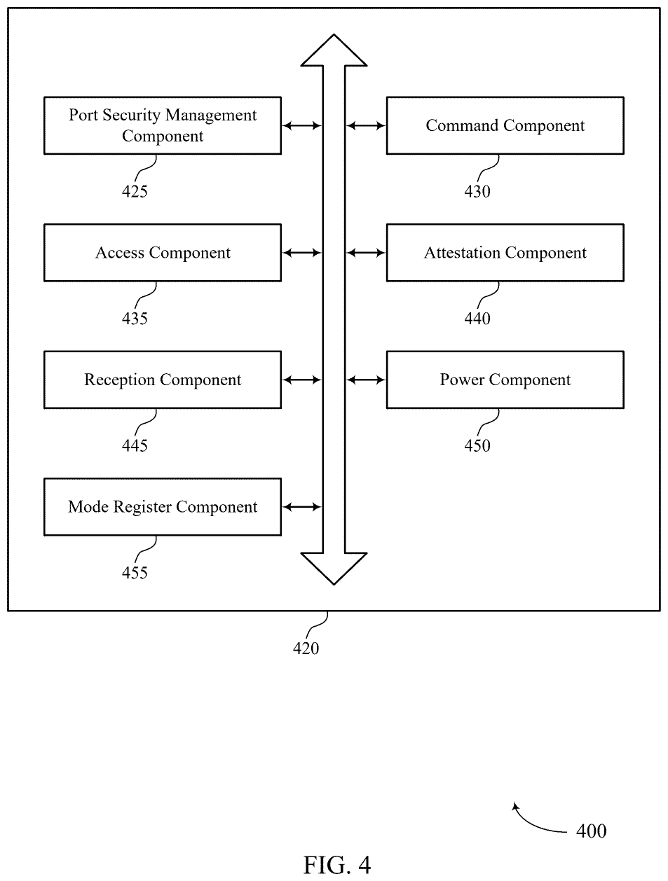

FIG. 4 shows a block diagram 400 of a memory system 420 that supports security management modes of a multi-port memory system in accordance with examples as disclosed herein. The memory system 420 may be an example of aspects of a memory system as described with reference to FIGS. 1 through 3. The memory system 420, or various components thereof, may be an example of means for performing various aspects of security management modes of a multi-port memory system as described herein. For example, the memory system 420 may include a port security management component 425, a command component 430, an access component 435, an attestation component 440, a reception component 445, a power component 450, a mode register component 455, or any combination thereof. Each of these components, or components of subcomponents thereof (e.g., one or more processors, one or more memories), may communicate, directly or indirectly, with one another (e.g., via one or more buses).

The port security management component 425 may be configured as or otherwise support a means for entering, based at least in part on a bootup sequence associated with the memory system, a port security management mode associated with reduced access, to the memory system, by one or more host systems prior to authentication of the one or more host systems with the memory system, where the one or more host systems are individually coupled with the memory system via one or more ports of the memory system. The command component 430 may be configured as or otherwise support a means for receiving, from a first host system of the one or more host systems via a first port of the one or more ports, one or more commands that request increased access for at least a second host system of the one or more host systems, where the second host system is coupled with the memory system via a second port of the one or more ports of the memory system. The access component 435 may be configured as or otherwise support a means for granting the increased access for at least the second host system that is coupled with the memory system via the second port based at least in part on the one or more commands from the first host system.

In some examples, the command component 430 may be configured as or otherwise support a means for receiving, from the second host system via the second port, one or more second commands based at least in part on granting the increased access for at least the second host system.

In some examples, the attestation component 440 may be configured as or otherwise support a means for granting, based at least in part on an attestation process between the memory system and the first host system, access by the first host system to the first port, where receiving the one or more commands that request the increased access for at least the second host system is based at least in part on granting the access by the first host system to the first port.

In some examples, the reception component 445 may be configured as or otherwise support a means for receiving a vendor specific command including an indication that the first port is a trusted port of the memory system, where receiving the one or more commands from the first host system via the first port is based at least in part on receiving the indication that the first port is the trusted port of the memory system.

In some examples, the attestation component 440 may be configured as or otherwise support a means for performing, based at least in part on receiving the one or more commands that request the increased access to at least the second host system, a second attestation process between the memory system and the second host system. In some examples, the access component 435 may be configured as or otherwise support a means for granting, based at least in part on the second attestation process, the increased access by at least the second host system to the memory system, where the port security management mode is associated with support, by the one or more ports, of a first set of commands from the one or more host systems, and where granting the increased access by at least the second host system includes permitting, by at least the second port, a second set of commands from at least the second host system, where a first quantity of commands included in the first set of commands is less than a second quantity of commands included in the second set of commands.

In some examples, the first set of commands, the second set of commands, or both are based at least in part on one or more values of one or more mode registers of the memory system, the one or more values indicating a configuration of the port security management mode.

In some examples, the reception component 445 may be configured as or otherwise support a means for receiving, from the first host system via the first port, a vendor specific command indicating a configuration of the port security management mode, where the configuration of the port security management mode indicates the first set of commands, the second set of commands, or both.

In some examples, the command component 430 may be configured as or otherwise support a means for receiving, from at least the second host system via the first port, a command of the second set of commands. In some examples, the command component 430 may be configured as or otherwise support a means for executing the command based at least in part on receiving the command via the first port and granting the increased access to at least the second host system.

In some examples, the command component 430 may be configured as or otherwise support a means for receiving, from a third host system via a third port, a first command of the first set of commands, the third host system being coupled with the memory system via the third port. In some examples, the command component 430 may be configured as or otherwise support a means for executing the first command based at least in part on receiving the first command from the third host system. In some examples, the command component 430 may be configured as or otherwise support a means for receiving, from the third host system via the third port, a second command of the second set of commands. In some examples, the command component 430 may be configured as or otherwise support a means for refraining from executing the second command based at least in part on receiving the second command from the third host system via the third port and reducing access by the third host system to the memory system in accordance with the port security management mode.

In some examples, the command component 430 may be configured as or otherwise support a means for receiving, from the first host system after refraining from executing the second command, one or more second commands that request the increased access by the third host system to the memory system. In some examples, the access component 435 may be configured as or otherwise support a means for granting the increased access by the third host system to the memory system based at least in part on receiving the one or more second commands from the first host system. In some examples, the command component 430 may be configured as or otherwise support a means for receiving, from the third host system via the third port, a third command of the second set of commands. In some examples, the command component 430 may be configured as or otherwise support a means for executing the third command based at least in part on receiving the third command and granting the increased access by the third host system to the memory system.

In some examples, the command component 430 may be configured as or otherwise support a means for receiving, from the first host system, one or more second commands that request the increased access for the first host system. In some examples, the access component 435 may be configured as or otherwise support a means for granting the increased access by the first host system to the memory system based at least in part on receiving the one or more second commands from the first host system.

In some examples, the power component 450 may be configured as or otherwise support a means for powering on the memory system. In some examples, the mode register component 455 may be configured as or otherwise support a means for reading, based at least in part on powering on the memory system, one or more values of one or more mode registers of the memory system, where entering the port security management mode is based at least in part on the one or more values of the one or more mode registers.

In some examples, the reception component 445 may be configured as or otherwise support a means for receiving a vendor specific command configuring the memory system in the port security management mode, where entering the port security management mode is based at least in part on receiving the vendor specific command.

In some examples, the port security management component 425 may be configured as or otherwise support a means for entering, at a first time prior to entering the port security management mode, a manufacturing mode of the memory system based at least in part on one or more values of one or more mode registers of the memory system, where the manufacturing mode is associated with unrestricted access by the one or more host systems to one or more second commands of the memory system. In some examples, the mode register component 455 may be configured as or otherwise support a means for reading, at a second time after the first time, one or more second values of the one or more mode registers of the memory system, where entering the port security management mode includes exiting the manufacturing mode prior to entering the port security management mode based at least in part on the one or more second values of the one or more mode registers.

In some examples, the described functionality of the memory system 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 420, or various components thereof, may be implemented at least in part by instructions (e.g., stored in memory, non-transitory computer-readable medium) executable by such at least one processor.

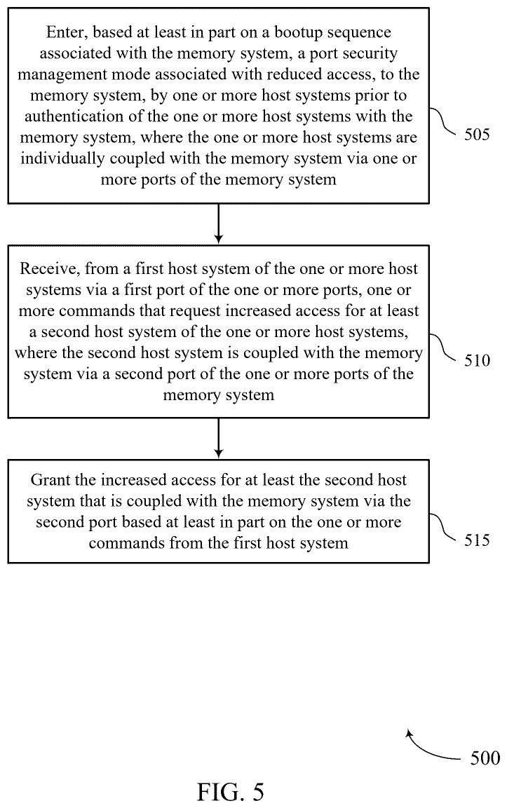

FIG. 5 shows a flowchart illustrating a method 500 that supports security management modes of a multi-port memory system in accordance with examples as disclosed herein. The operations of method 500 may be implemented by a memory system or its components as described herein. For example, the operations of method 500 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 505, the method may include entering, based at least in part on a bootup sequence associated with the memory system, a port security management mode associated with reduced access, to the memory system, by one or more host systems prior to authentication of the one or more host systems with the memory system, where the one or more host systems are individually coupled with the memory system via one or more ports of the memory system. In some examples, aspects of the operations of 505 may be performed by a port security management component 425 as described with reference to FIG. 4.

At 510, the method may include receiving, from a first host system of the one or more host systems via a first port of the one or more ports, one or more commands that request increased access for at least a second host system of the one or more host systems, where the second host system is coupled with the memory system via a second port of the one or more ports of the memory system. In some examples, aspects of the operations of 510 may be performed by a command component 430 as described with reference to FIG. 4.

At 515, the method may include granting the increased access for at least the second host system that is coupled with the memory system via the second port based at least in part on the one or more commands from the first host system. In some examples, aspects of the operations of 515 may be performed by an access component 435 as described with reference to FIG. 4.

In some examples, an apparatus as described herein may perform a method or methods, such as the method 500. The apparatus may include features, circuitry, logic, means, or instructions (e.g., a non-transitory computer-readable medium storing instructions executable by a processor), or any combination thereof for performing the following aspects of the present disclosure:
Aspect 1: A method, apparatus, or non-transitory computer-readable medium including operations, features, circuitry, logic, means, or instructions, or any combination thereof for entering, based at least in part on a bootup sequence associated with the memory system, a port security management mode associated with reduced access, to the memory system, by one or more host systems prior to authentication of the one or more host systems with the memory system, where the one or more host systems are individually coupled with the memory system via one or more ports of the memory system; receiving, from a first host system of the one or more host systems via a first port of the one or more ports, one or more commands that request increased access for at least a second host system of the one or more host systems, where the second host system is coupled with the memory system via a second port of the one or more ports of the memory system; and granting the increased access for at least the second host system that is coupled with the memory system via the second port based at least in part on the one or more commands from the first host system.
Aspect 2: The method, apparatus, or non-transitory computer-readable medium of aspect 1, further including operations, features, circuitry, logic, means, or instructions, or any combination thereof for receiving, from the second host system via the second port, one or more second commands based at least in part on granting the increased access for at least the second host system.
Aspect 3: The method, apparatus, or non-transitory computer-readable medium of any of aspects 1 through 2, further including operations, features, circuitry, logic, means, or instructions, or any combination thereof for granting, based at least in part on an attestation process between the memory system and the first host system, access by the first host system to the first port, where receiving the one or more commands that request the increased access for at least the second host system is based at least in part on granting the access by the first host system to the first port.
Aspect 4: The method, apparatus, or non-transitory computer-readable medium of any of aspects 1 through 3, further including operations, features, circuitry, logic, means, or instructions, or any combination thereof for receiving a vendor specific command including an indication that the first port is a trusted port of the memory system, where receiving the one or more commands from the first host system via the first port is based at least in part on receiving the indication that the first port is the trusted port of the memory system.
Aspect 5: The method, apparatus, or non-transitory computer-readable medium of any of aspects 1 through 4, further including operations, features, circuitry, logic, means, or instructions, or any combination thereof for performing, based at least in part on receiving the one or more commands that request the increased access to at least the second host system, a second attestation process between the memory system and the second host system and granting, based at least in part on the second attestation process, the increased access by at least the second host system to the memory system, where the port security management mode is associated with support, by the one or more ports, of a first set of commands from the one or more host systems, and where granting the increased access by at least the second host system includes permitting, by at least the second port, a second set of commands from at least the second host system, where a first quantity of commands included in the first set of commands is less than a second quantity of commands included in the second set of commands.
Aspect 6: The method, apparatus, or non-transitory computer-readable medium of aspect 5, where the first set of commands, the second set of commands, or both are based at least in part on one or more values of one or more mode registers of the memory system, the one or more values indicating a configuration of the port security management mode.
Aspect 7: The method, apparatus, or non-transitory computer-readable medium of any of aspects 5 through 6, further including operations, features, circuitry, logic, means, or instructions, or any combination thereof for receiving, from the first host system via the first port, a vendor specific command indicating a configuration of the port security management mode, where the configuration of the port security management mode indicates the first set of commands, the second set of commands, or both.
Aspect 8: The method, apparatus, or non-transitory computer-readable medium of any of aspects 5 through 7, further including operations, features, circuitry, logic, means, or instructions, or any combination thereof for receiving, from at least the second host system via the first port, a command of the second set of commands and executing the command based at least in part on receiving the command via the first port and granting the increased access to at least the second host system.
Aspect 9: The method, apparatus, or non-transitory computer-readable medium of any of aspects 5 through 8, further including operations, features, circuitry, logic, means, or instructions, or any combination thereof for receiving, from a third host system via a third port, a first command of the first set of commands, the third host system being coupled with the memory system via the third port; executing the first command based at least in part on receiving the first command from the third host system; receiving, from the third host system via the third port, a second command of the second set of commands; and refraining from executing the second command based at least in part on receiving the second command from the third host system via the third port and reducing access by the third host system to the memory system in accordance with the port security management mode.
Aspect 10: The method, apparatus, or non-transitory computer-readable medium of aspect 9, further including operations, features, circuitry, logic, means, or instructions, or any combination thereof for receiving, from the first host system after refraining from executing the second command, one or more second commands that request the increased access by the third host system to the memory system; granting the increased access by the third host system to the memory system based at least in part on receiving the one or more second commands from the first host system; receiving, from the third host system via the third port, a third command of the second set of commands; and executing the third command based at least in part on receiving the third command and granting the increased access by the third host system to the memory system.
Aspect 11: The method, apparatus, or non-transitory computer-readable medium of any of aspects 1 through 10, further including operations, features, circuitry, logic, means, or instructions, or any combination thereof for receiving, from the first host system, one or more second commands that request the increased access for the first host system and granting the increased access by the first host system to the memory system based at least in part on receiving the one or more second commands from the first host system.
Aspect 12: The method, apparatus, or non-transitory computer-readable medium of any of aspects 1 through 11, further including operations, features, circuitry, logic, means, or instructions, or any combination thereof for powering on the memory system and reading, based at least in part on powering on the memory system, one or more values of one or more mode registers of the memory system, where entering the port security management mode is based at least in part on the one or more values of the one or more mode registers.
Aspect 13: The method, apparatus, or non-transitory computer-readable medium of any of aspects 1 through 12, further including operations, features, circuitry, logic, means, or instructions, or any combination thereof for receiving a vendor specific command configuring the memory system in the port security management mode, where entering the port security management mode is based at least in part on receiving the vendor specific command.
Aspect 14: The method, apparatus, or non-transitory computer-readable medium of any of aspects 1 through 13, further including operations, features, circuitry, logic, means, or instructions, or any combination thereof for entering, at a first time prior to entering the port security management mode, a manufacturing mode of the memory system based at least in part on one or more values of one or more mode registers of the memory system, where the manufacturing mode is associated with unrestricted access by the one or more host systems to one or more second commands of the memory system and reading, at a second time after the first time, one or more second values of the one or more mode registers of the memory system, where entering the port security management mode includes exiting the manufacturing mode prior to entering the port security management mode based at least in part on the one or more second values of the one or more mode registers.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed, and a second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed, and a second condition or action may occur directly as a result of the previous condition or action occurring independent of whether other conditions or actions occur. In some examples, a first condition or action may be performed, and a second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively, (e.g., in an alternative example), be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry, processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
enter, based at least in part on a bootup sequence associated with the memory system, a port security management mode associated with reduced access, to the memory system, by one or more host systems prior to authentication of the one or more host systems with the memory system, wherein the one or more host systems are individually coupled with the memory system via one or more ports of the memory system;
receive, from a first host system of the one or more host systems via a first port of the one or more ports, one or more commands that request increased access for at least a second host system of the one or more host systems, wherein the second host system is coupled with the memory system via a second port of the one or more ports of the memory system; and
grant the increased access for at least the second host system that is coupled with the memory system via the second port based at least in part on the one or more commands from the first host system.

2. The memory system of claim 1, wherein the processing circuitry is further configured to cause the memory system to:
receive, from the second host system via the second port, one or more second commands based at least in part on granting the increased access for at least the second host system.

3. The memory system of claim 1, wherein the processing circuitry is further configured to cause the memory system to:
grant, based at least in part on an attestation process between the memory system and the first host system, access by the first host system to the first port, wherein receiving the one or more commands that request the increased access for at least the second host system is based at least in part on granting the access by the first host system to the first port.

4. The memory system of claim 1, wherein the processing circuitry is further configured to cause the memory system to:
receive a vendor specific command comprising an indication that the first port is a trusted port of the memory system, wherein receiving the one or more commands from the first host system via the first port is based at least in part on receiving the indication that the first port is the trusted port of the memory system.

5. The memory system of claim 1, wherein the processing circuitry is further configured to cause the memory system to:
perform, based at least in part on receiving the one or more commands that request the increased access to at least the second host system, a second attestation process between the memory system and the second host system; and
grant, based at least in part on the second attestation process, the increased access by at least the second host system to the memory system, wherein the port security management mode is associated with support, by the one or more ports, of a first set of commands from the one or more host systems, and wherein granting the increased access by at least the second host system comprises permitting, by at least the second port, a second set of commands from at least the second host system, wherein a first quantity of commands included in the first set of commands is less than a second quantity of commands included in the second set of commands.

6. The memory system of claim 5, wherein the first set of commands, the second set of commands, or both are based at least in part on one or more values of one or more mode registers of the memory system, the one or more values indicating a configuration of the port security management mode.

7. The memory system of claim 5, wherein the processing circuitry is further configured to cause the memory system to:
receive, from the first host system via the first port, a vendor specific command indicating a configuration of the port security management mode, wherein the configuration of the port security management mode indicates the first set of commands, the second set of commands, or both.

8. The memory system of claim 5, wherein the processing circuitry is further configured to cause the memory system to:
receive, from at least the second host system via the first port, a command of the second set of commands; and
execute the command based at least in part on receiving the command via the first port and granting the increased access to at least the second host system.

9. The memory system of claim 5, wherein the processing circuitry is further configured to cause the memory system to:
receive, from a third host system via a third port, a first command of the first set of commands, the third host system being coupled with the memory system via the third port;
execute the first command based at least in part on receiving the first command from the third host system;
receive, from the third host system via the third port, a second command of the second set of commands; and
refrain from executing the second command based at least in part on receiving the second command from the third host system via the third port and reducing access by the third host system to the memory system in accordance with the port security management mode.

10. The memory system of claim 9, wherein the processing circuitry is further configured to cause the memory system to:
receive, from the first host system after refraining from executing the second command, one or more second commands that request the increased access by the third host system to the memory system;
grant the increased access by the third host system to the memory system based at least in part on receiving the one or more second commands from the first host system;
receive, from the third host system via the third port, a third command of the second set of commands; and
execute the third command based at least in part on receiving the third command and granting the increased access by the third host system to the memory system.

11. The memory system of claim 1, wherein the processing circuitry is further configured to cause the memory system to:
receive, from the first host system, one or more second commands that request the increased access for the first host system; and
grant the increased access by the first host system to the memory system based at least in part on receiving the one or more second commands from the first host system.

12. The memory system of claim 1, wherein the processing circuitry is further configured to cause the memory system to:
power on the memory system; and
read, based at least in part on powering on the memory system, one or more values of one or more mode registers of the memory system, wherein entering the port security management mode is based at least in part on the one or more values of the one or more mode registers.

13. The memory system of claim 1, wherein the processing circuitry is further configured to cause the memory system to:
receive a vendor specific command configuring the memory system in the port security management mode, wherein entering the port security management mode is based at least in part on receiving the vendor specific command.

14. The memory system of claim 1, wherein the processing circuitry is further configured to cause the memory system to:
enter, at a first time prior to entering the port security management mode, a manufacturing mode of the memory system based at least in part on one or more values of one or more mode registers of the memory system, wherein the manufacturing mode is associated with unrestricted access by the one or more host systems to one or more second commands of the memory system; and
read, at a second time after the first time, one or more second values of the one or more mode registers of the memory system, wherein entering the port security management mode comprises exiting the manufacturing mode prior to entering the port security management mode based at least in part on the one or more second values of the one or more mode registers.

15. A non-transitory computer-readable medium storing code, the code comprising instructions executable by one or more processors to:
enter, based at least in part on a bootup sequence associated with a memory system, a port security management mode associated with reduced access, to the memory system, by one or more host systems prior to authentication of the one or more host systems with the memory system, wherein the one or more host systems are individually coupled with the memory system via one or more ports of the memory system;
receive, from a first host system of the one or more host systems via a first port of the one or more ports, one or more commands that request increased access for at least a second host system of the one or more host systems, wherein the second host system is coupled with the memory system via a second port of the one or more ports of the memory system; and
grant the increased access for at least the second host system that is coupled with the memory system via the second port based at least in part on the one or more commands from the first host system.

16. The non-transitory computer-readable medium of claim 15, wherein the instructions are further executable by the one or more processors to:
receive, from the second host system via the second port, one or more second commands based at least in part on granting the increased access for at least the second host system.

17. The non-transitory computer-readable medium of claim 15, wherein the instructions are further executable by the one or more processors to:
grant, based at least in part on an attestation process between the memory system and the first host system, access by the first host system to the first port, wherein receiving the one or more commands that request the increased access for at least the second host system is based at least in part on granting the access by the first host system to the first port.

18. The non-transitory computer-readable medium of claim 15, wherein the instructions are further executable by the one or more processors to:
receive a vendor specific command comprising an indication that the first port is a trusted port of the memory system, wherein receiving the one or more commands from the first host system via the first port is based at least in part on receiving the indication that the first port is the trusted port of the memory system.

19. The non-transitory computer-readable medium of claim 15, wherein the instructions are further executable by the one or more processors to:
perform, based at least in part on receiving the one or more commands that request the increased access to at least the second host system, a second attestation process between the memory system and the second host system; and
grant, based at least in part on the second attestation process, the increased access by at least the second host system to the memory system, wherein the port security management mode is associated with support, by the one or more ports, of a first set of commands from the one or more host systems, and wherein granting the increased access by at least the second host system comprises permitting, by at least the second port, a second set of commands from at least the second host system, wherein a first quantity of commands included in the first set of commands is less than a second quantity of commands included in the second set of commands.

20. The non-transitory computer-readable medium of claim 19, wherein the first set of commands, the second set of commands, or both are based at least in part on one or more values of one or more mode registers of the memory system, the one or more values indicating a configuration of the port security management mode.

21. The non-transitory computer-readable medium of claim 19, wherein the instructions are further executable by the one or more processors to:
receive, from the first host system via the first port, a vendor specific command indicating a configuration of the port security management mode, wherein the configuration of the port security management mode indicates the first set of commands, the second set of commands, or both.

22. The non-transitory computer-readable medium of claim 19, wherein the instructions are further executable by the one or more processors to:
receive, from at least the second host system via the first port, a command of the second set of commands; and
execute the command based at least in part on receiving the command via the first port and granting the increased access to at least the second host system.

23. A method by a memory system, comprising:
entering, based at least in part on a bootup sequence associated with the memory system, a port security management mode associated with reduced access, to the memory system, by one or more host systems prior to authentication of the one or more host systems with the memory system, wherein the one or more host systems are individually coupled with the memory system via one or more ports of the memory system;
receiving, from a first host system of the one or more host systems via a first port of the one or more ports, one or more commands that request increased access for at least a second host system of the one or more host systems, wherein the second host system is coupled with the memory system via a second port of the one or more ports of the memory system; and
granting the increased access for at least the second host system that is coupled with the memory system via the second port based at least in part on the one or more commands from the first host system.
